(19) United States
(12) Patent Application Publication
(10) Pub. No.: US 2016/0150798 A1
(43) Pub. Date: Jun. 2, 2016

(54) Ready-To-Bake Gluten-Free Pizza Dough Formulations

(71) Applicant: GENERAL MILLS INC., Minneapolis, MN (US)

(72) Inventors: Michelle Dacey, Golden Valley, MN (US); Christine O'Connor, Rogers, MN (US)

(73) Assignee: General Mills, Inc., Minneapolis, MN (US)

(21) Appl. No.: 14/894,081

(22) PCT Filed: May 31, 2013
(86) PCT No.: PCT/US13/43754

§ 371 Date: Nov. 25, 2015

(51) Int. Cl. A21D 13/06; A21D 13/00; A21D 2/18; A21D 2/16; A21D 2/34; A21D 10/02; A21D 13/04

(52) U.S. Cl. CPC A21D 13/066; A21D 10/025; A21D 13/007; A21D 13/04; A21D 2/165; A21D 2/34; A21D 2/186; A21D 2/181

(57) ABSTRACT

A composition includes a gluten-free flour mixture constituting 45-55% by weight of the composition, dried egg whites constituting 1.75-4.5% by weight of the composition, oil constituting 1.5-2% by weight of the composition, shortening constituting 3-7% by weight of the composition, water constituting 26-33% by weight of the composition, ethanol constituting 1-2% by weight of the composition and sucrose constituting less than 5% by weight of the composition. The gluten-free flour mixture includes less than 12% rice flour by weight of the composition and includes at least one of tapioca starch, sorghum flour and millet flour. The composition has a water activity of 0.93 or lower. Methods of manufacturing the composition are also provided.

### BACKGROUND

Gluten is a protein found in a variety of grains including wheat, rye, and barley, with wheat containing the highest levels of gluten when compared to other cereal grains. Although wheat flour is typically referred to as containing gluten, in reality, wheat flour contains two proteins, gliadin and glutenin, which when hydrated combine to form gluten.

Gluten is responsible for the texture and taste of wheat flour-based baked goods such as pizza crusts, cookies, pie crusts, brownies, and breads. Upon hydration, gluten forms a network of fine strands that give the dough structure and the capacity to stretch and/or rise during baking. The elasticity of gluten enables the dough to trap gases, which create open cellular structures upon baking.

Gluten also affects the viscosity of dough. As described above, gluten forms the structure of the dough. The extent of the network of gluten strands impacts whether a mixture is thin and runny, like a batter, or is thick, like a dough. For a pizza crust, for example, wheat flour can make up a substantial amount of the composition.

Some individuals are sensitive or intolerant to gluten. Recently there has been a growing trend to provide gluten-free baked goods. While consumers are demanding gluten-free products, it is very difficult to produce gluten-free products having a similar taste and texture as traditional gluten and/or wheat flour containing products. As described above, gluten provides the structure or framework for traditional baked goods. When wheat flour is replaced with a gluten-free flour such as rice flour, the dough lacks the matrix to create the structure and texture typically associated with comparable gluten containing baked goods. For example, gluten-free dough may not have the same elasticity as a gluten dough, and may be drier and more difficult to handle.

Dry gluten-free pizza crusts mixes are commercially available. For example, consumers can combine these dry mixes with one or more of water, egg, oil, and yeast to produce a dough which is then cooked. In some instances the consumer is required to let the dough rise for a period of time before baking.

There are also several frozen gluten-free pizza crusts that are commercially available. Some frozen gluten-free pizza crusts are ready for a consumer to add the toppings of their choice. In some instances, frozen pizzas having gluten-free crusts are available ready to bake, with toppings already distributed on the crust. However, neither of the gluten-free pizza crust mixes or frozen gluten-free pizza crusts provide the taste, texture and other organoleptic properties that are provided by a gluten-based pizza crust.

Further, consumers enjoy the modern convenience of ready-to-bake products which can go directly from the pantry, refrigerator or freezer to the oven or other associated baking appliance without the need for additional preparation steps and/or the addition of ingredients. Particularly, there is demand for ready-to-bake gluten-free products that can go directly from the refrigerator to the oven or other associated baking appliance.

Ready-to-bake gluten-free dough adds additional challenges including shelf stability, dough handling properties and the inability for consumers to adjust or manipulate the ingredients of the dough. Ready-to-bake products must be capable of being stored under refrigerated conditions for an extended period of time (i.e., at least 75 days, at least 90 days, or for up to 120 days).

Ready-to-bake doughs also face the additional challenge that the consumers cannot change or adjust the ingredients of the dough. Unlike dry mixes in which the consumer can adjust the amount of certain ingredients added to the dough to adjust the composition, the consumer is unable to add or adjust the content of a ready-to-bake dough.

### SUMMARY

The present invention relates to shelf stable, ready-to-bake gluten-free pizza crust dough formulations and methods of making these formulations.

According to some embodiments, the ready-to-bake pizza dough includes a gluten-free flour mixture constituting from 48% to 55% by weight of the composition, dried egg whites constituting from 1.75% to 4.5% by weight of the composition, oil constituting from 1.5% to 2% by weight of the composition, shortening constituting from 3% to 5% by weight of the composition, water constituting from 26% to 33% by weight of the composition and sucrose constituting less than 5% by weight of the composition. The composition includes ethanol constituting from 1% to 2% by weight of the composition. The gluten-free flour mixture includes less than 12% by weight rice flour, and includes at least one of tapioca starch, sorghum flour, millet flour and combinations thereof. The composition has a water activity of 0.93 or lower.

In another embodiment, a raw dough product is manufactured by combining rice flour and at least one of tapioca starch, sorghum flour, millet flour and combinations thereof, dried egg whites, oil, shortening, water, ethanol and sucrose, forming a raw dough product and packaging the raw dough product. The raw dough product has a water activity of 0.93 or less.

While multiple embodiments are disclosed, still other embodiments of the present invention will become apparent to those skilled in the art from the following detailed description, which shows and describes illustrative embodiments of the invention. Accordingly, the drawings and detailed description are to be regarded as illustrative in nature and not restrictive.

### DETAILED DESCRIPTION

The current invention relates to ready-to-bake gluten-free pizza crusts. In some embodiments, the gluten-free pizza dough resembles a gluten containing dough, is capable of being stored for a long period time in the refrigerator without the need for hermetic or pressurized sealing, and produces a baked product comparable to that obtained with gluten containing pizza crusts. In some embodiments, the gluten-free pizza dough can be packaged in a form that is ready to bake.

In some embodiments, the gluten-free pizza dough can include a flour mixture and additional ingredients such as eggs, oil, shortening, sugar and water. In some embodiments, the gluten-free pizza dough can have a water activity that is less than about 0.93 and can have a pH that is between about 6 and 7. Gluten-free pizza doughs according to embodiments of the present invention contain less than 20 ppm gluten and more particularly less than 0% by weight of gluten. In some embodiments, gluten content may be determined based on the gliadin component. A suitable method for determining the gluten content of a food product is provided in Association of Analytical Communities (AOAC) Official Method 991.19: Gliadin as a Measure of Gluten in Foods (final action 2001).

In some embodiments, the pizza dough may include from about 37.1% to about 42% liquid ingredients, including fat (i.e., oil and solid shortening) and water, by weight of the dough, and from about 53.5% to about 63% dry ingredients, including the gluten-free flour mixture and sugar, by weight of the dough.

In some embodiments, the gluten-free flour mixture may be present in the ready-to-bake gluten-free pizza dough in an amount from about 45% to about 55% by weight of the dough. The gluten-free flour mixture may include, consist essentially of or consist of rice flour and at least one of tapioca starch, sorghum flour, millet flour and combinations thereof. The gluten-free flour mixture is a substitute for wheat flour and/or other gluten containing flours traditionally used in pizza crust dough. Potato starch and corn starch may optionally be used in place of the tapioca starch. The combination of several ingredients described herein contained in the gluten-free flour mixture provide a ready-to-bake pizza crust having the taste, texture and rheology similar to that of gluten containing Boughs, and which provide a baked pizza crust having the organoleptic properties of a gluten-based pizza crust.

Rice flour does not contain either gliadin or glutenin. In some embodiments, to prevent a gritty baked pizza crust, the dough may include less than about 12% by weight of rice flour. Suitable forms of rice flour include short grain and long grain white and brown rice flour. The rice flour may be present in amount from about 7% to about 10% by weight of the dough.

Because the rice flour is not a direct substitute for wheat flour, the gluten-free flour mixture also includes modified or unmodified tapioca starch and optionally additional starches to provide additional structural and textural properties that rice flour alone cannot provide. In some embodiments, tapioca starch may be present in an amount from 15% to 25% by weight of the dough composition. The inclusion of tapioca starch may provide a smoother texture dough. In some embodiments, a pizza dough containing less than about 15% by weight of tapioca starch may provide a baked crust having a gritty texture, while a pizza dough having greater than about 25% by weight of tapioca starch may produce a baked product which does not have a desired moisture level. For example, the baked crust may have a dry or crumbly texture.

The gluten-free flour mixture can include sorghum flour. In some embodiments, sorghum flour may be present in an amount from 8% to 20% by weight of the composition. The inclusion of sorghum flour may provide more body and better mouth feel to the overall texture of the dough. Sorghum flour has a bland flavor profile, making it a good alternative to rice flour, as rice flour can cause grittiness if included in the dough at too high an amount. In some embodiments, a pizza dough containing less than about 8% by weight of sorghum flour may be gritty, if the dough includes too much rice flour as a substitute, or may have off flavors caused by other substitutes. A pizza dough having greater than about 20% by weight sorghum flour may have a mild sweet nutty flavor and may include brown flecks.

The gluten-free mixture can include millet flour. In some embodiments, the millet flour may be present in an amount from 8% to 20% by weight of the composition. The inclusion of millet flour may provide a suitable substitute for rice flour. In some embodiments, a pizza dough containing less than about 8% by weight of millet flour may be gritty, if the dough includes too much rice flour as a substitute, or may have off flavors caused by other substitutes, while a pizza dough having greater than about 20% by weight of millet flour may be too sweet and have a “whole wheat” flavor.

The ready-to-bake dough also includes from about 3% to about 7% by weight shortening. Animal or vegetable based natural shortenings can be used, as can synthetic shortenings. Shortening is generally comprised of triglycerides, fats and fatty oils that are made predominantly from tri-esters of glycerol with fatty acids. Fats and fatty oils that may be found in the shortening include cottonseed oil, nut oil, soybean oil, sunflower oil, rapeseed oil, sesame oil, olive oil, corn oil, safflower oil, palm oil, palm kernel oil, coconut oil, and combinations thereof. In some embodiments, the shortening may be hydrogenated shortening. The shortening may have beneficial effects on the volume, grain and texture of the dough, as well as the texture, mouth feel and other organoleptic properties of the baked product.

In some embodiments, the shortening may affect the spread of the dough during baking. For example, in some embodiments, the inclusion of less than 3% shortening may result in a baked product that has an insufficient amount of spread, is difficult to handle, and that is dry, while too much shortening may result in a baked product that is undesirably soft as compared to the typical gluten containing pizza crust.

The ready-to-bake dough also includes sugars. Useful sugars include saccharides such as monosaccharides and disaccharides. Monosaccharides typically have 5 or 6 carbon atoms, and have the general empirical formula Cₙ(H₂O)ₙ. Disaccharides consist of two monosaccharides joined together with the concomitant loss of a water molecule. Illustrative but non-limiting examples of suitable sugars include pentoses such as fructose, xylose, arabinose, glucose, galactose, amylose, fructose, sorbose, lactose, maltose, dextrose, sucrose, maltodextrins, high fructose corn syrup (HFCS), molasses and brown sugar.

In some embodiments, the ready-to-bake dough includes less than about 5% by weight of sucrose. Suitable sucrose includes white sugar, brown sugar and combinations thereof For example, in some embodiments, the ready-to-bake dough may include from about 2% to about 3.5% by weight brown or white sugar. In some embodiments, the ready-to-bake dough may include fructose in an amount from 3.5% to 4.5% by weight of the composition.

In some embodiments, the sucrose source may affect the color and flavor (i.e., sweetness) of the baked product. For example, in some embodiments, the inclusion of brown sugar may produce a darker baked product as compared to a product in which all or a portion of the brown sugar is substituted with granulated white sugar. Sucrose is present in the ready-to-bake dough to provide sweetness and may affect the spread of the dough during baking.

Sugar may lower the water activity, a_{w}, of the dough. Water activity is a measure of the equilibrated water vapor pressure generated by the product divided by the vapor pressure of pure water at the same temperature as shown in Formula (1).

α_{w}≡p/p₀ (1)

where p is the vapor pressure of water in the substance, and p₀ is the vapor pressure of pure water at the same temperature.

Lowering the water activity provides the microbial stability required to impart shelf stability under refrigerated conditions for extended periods of time (e.g., at least about 75 days or at least about 90 days). In some embodiments, the dough of the invention has a water activity of less than about 0.93. For example, the dough of the invention may have a water activity of between about 0.85 and 0.94.

If the water activity is higher, then microbial stability over extended periods of time is reduced unless the water in the dough is frozen. If the water activity is lower, then the microbial stability under refrigeration temperatures satisfactory, but the amount of water available is so low that the resulting end product may not have a high volume and fluffy texture and may be unacceptably dry. If the water activity is too low, the dough would be very crumbly and the consumer would not be able to easily roll the dough out.

As described herein, sucrose may lower the water activity of the dough. Because the sucrose also impart sweetness to the baked product, the kind and amount of sucrose is selected to achieve a balance between reducing the water activity of the composition a sufficient amount to provide microbial stability and obtaining the desired degree and quality of sweetness in the baked product. This can be achieved by balancing both the ratios of various sugar sources to one another and the ratios of sugar to water in the dough.

The ready-to-bake dough may further include water in an amount ranging from about 26% by weight to about 33% by weight. In some embodiments, the dough includes water ranging from about 26% by weight to about 30% by weight. In some embodiments, the dough includes water ranging from about 30% by weight to about 33% by weight of the composition. The water content affects the texture and consistency of the ready-to-bake dough, as well as the water activity. In some embodiments, it is desired to produce a ready-to-bake dough that has the same texture and consistency as a typical gluten containing dough, i.e, a dough that is crust-formable and that is sufficiently moist to enable the dough to be rolled flat for baking without crumbling.

The ready-to-bake dough may include a chemical leavening system. A chemical leavening system may include an acid and a base that can react to form carbon dioxide. Suitable leavening systems may include baking soda (sodium bicarbonate or potassium bicarbonate), monocalcium phosphate monohydrate (MCP), monocalcium phosphate anhydrous (AMCP), sodium acid pyrophosphate (SAPP), sodium aluminum phosphate (SALP), dicalcium phosphate dihydrate (DPD), dicalcium phosphate (DCP), sodium aluminum sulfate (SAS), glucono-deltalactone (GDL), potassium hydrogen tartrate (cream of tartar), and the like.

Baking soda is a leavening base and is the primary source of carbon dioxide in many chemical leavening systems. This compound is stable and relatively inexpensive to produce. Baking soda can be used in either an encapsulated form or in a non-encapsulated form. Use of an encapsulated baking soda delays the onset of the leavening reaction as the encapsulating material must first be dissolved before the leavening reaction can occur. In some embodiments, the dough may include from about 0.3% to about 0.6% of a leavening system, such as baking soda, by weight. In some embodiments, the dough may include baking powder in an amount from about 0.4% to about 0.8% by weight of the dough.

Hydrocolloids or gums, can be added to the dough formulation to give structure to the dough and bind ingredients (i.e., to create a suitable matrix within the dough in the absence of gluten). For example, hydrocolloids may be added to improve the rheology and crumb texture by stabilizing small air cells within the dough and bind to moisture. Hydrocolloids are hydrophilic polymers that contain hydroxyl groups and may be polyelectrolytes. Suitable hydrocolloids may be of vegetable, animal, microbial or synthetic origin. Suitable hydrocolloids include xanthan gum, guar gum, locust bean gum, carrageenan gum and the like. In some embodiments, hydrocollodis or gums may be present in an amount from about 0.5% to about 2% by weight of the dough.

In some embodiments, the ready-to-bake pizza crust dough may include egg solids. Suitable sources of egg solids include whole eggs (albumen and yolk) and dried whole eggs. Egg whites and dried egg whites may also be used. The egg solids also contribute to structure to the dough. More specifically, the proteins of the eggs solids provide a matrix or bind the ingredients together to form a suitable dough. In some embodiments, it has been found that the inclusion of eggs and/or egg whites may reduce oil migration in the dough. In some embodiments, dried egg whites may be present in an amount from about 1.75% to 4.5% by weight of the composition. In some embodiments, dried egg whites may have impact on the overall color and appearance of the pizza dough, as the egg yolks can yellow the pizza dough. In some embodiments, if dried eggs are used, it may be necessary to increase the percentage of egg solids as compared to the percentage of egg white solids.

In some embodiments, the ready-to-bake pizza crust dough may include oil. A variety of different oils may be used, including palm oil, coconut oil, cottonseed oil, peanut oil, olive oil, sunflower seed oil, sesame seed oil, corn oil, safflower oil, poppy seed oil, soybean oil, canola oil and combinations thereof In some embodiments, a combination of soybean oil and olive oil may be used. In some embodiments, the oil may be present in an amount ranging from 1.5% to about 2% by weight of the dough composition. In some embodiments, a pizza dough containing less than about 1.5% by weight of oil may be too hard, while a pizza dough containing more than about 2% by weight of oil may oil out, i.e., the dough may turn brown and oil may seep out of the dough.

In some embodiments, the ready-to-bake pizza dough may include one or more natural and/or synthetic bread flavors. In some embodiments, the ready-to-bake pizza dough may include a bread flavoring agent containing ethanol. The ethanol may also provide microbiological benefits. The ethanol may be present in an amount ranging from about 1% by weight to about 2% by weight of the composition.

In some embodiments, the ready-to-bake dough may include one or more antimycotic agent(s) to enhance microbial stability. Useful agents include sorbic acid and its derivatives such as sodium or potassium sorbate, propionic acid and its derivatives, vinegar, sodium diacetate, monocalcium phosphate, lactic acid, citric acid and the like. These agents are present in an amount effective to inhibit the growth of undesired yeast and/or molds, typically in amount from about 0.1% to about 0.2% by weight of the dough. Too little will not provide sufficient antimycotic effect, while too much can impart an off taste to the dough.

The microbial stability of the dough may also be enhanced by maintaining the pH of the composition at a relatively low level such as about 6.0 to 7.0, preferably about 6.5 to 6.7.

In some embodiments, the rice flour may be heat treated before addition to the ready-to-bake dough to reduce and/or eliminate micro-organisms. For example, radio waves, such as microwaves, may be applied to the rice flour at a sufficient time and temperature to reduce the microbiological activity of the flour by a sufficient amount, such as at least a five log reduction. If the rice flour is not treated at a high enough temperature and/or for a long enough time period (i.e., under treated), the microbiological activity of the flour may not be sufficiently reduced. Further, if the rice flour is treated at too high of a temperature and/or for too long of a time period (i.e., over treated) the flour may be clumpy and may produce undesired lumps in the resulting dough. Additionally or alternatively, other flours included in the gluten-free flour mixture may also be treated to reduce and/or eliminate microbiological activity.

In addition to the foregoing, other ingredients known to those of skill in the art can be included in the compositions to give a variety of desired properties, flavors and/or textures. Examples of these ingredients include flavoring and coloring agents, flavors, spices, and the like.

Exemplary ready-to-bake stable pizza dough compositions are provided in Table 1 and exemplary gluten-free flour mixtures for inclusion in the dough composition are provided in Table 2. All components in Table 1 and Table 2 are provided as weight percent of the dough composition.

TABLE 1
Ready-to-bake pizza dough compositions

| | Range (% by | Range (% by |
|---|---|---|
| | weight of | weight of |
| | composition) | composition) |
| gluten-free flour mixture | 45-55 | 48-55 |
| dried egg whites | 1.75-4.5 | 1.75-4.5 |
| oil | 1.5-2 | 1.5-2 |
| shortening | 3-7 | 3-5 |
| ethanol | 1-2 | 1-2 |
| sucrose | <5 | <5 |
| fructose | 3.5-4.5 | 3.5-4.5 |
| gum | 0.5-2 | 0.5-1 |
| water | 26-33 | 26-30 |

TABLE 2
Gluten-free flour mixture

| | Range (% by | Range (% by |
|---|---|---|
| | weight of dough) | weight of dough) |
| rice flour | <12 | 7-10 |
| tapioca starch | 15-25 | 18-24 |
| sorghum flour | 8-20 | 9-12 |
| millet flour | 8-20 | 9-12 |

The ready-to-bake dough may be prepared by combining the ingredients by stirring in a standard mixer such as a Sigma mixer. Preferably the mixing is carried out under refrigerated conditions, about 35 to 68° F. (1-20° C.). The pizza dough is made in a two stage process. In the first stage, all of the dry ingredients are blended together. In the second stage, the fats, water and any flavorings are added to the dry ingredients and are mixed together for an optimum time.

The order of addition of ingredients is not critical. For example, the leavening agent (i.e., baking powder) can be added to the other dry ingredients or the leavening agent can be added to the dough as a slurry. After mixing is complete, the dough can be pumped into a filler, and the dough can be placed in suitable containers, such as by extrusion. The containers can be of any desired shape, such as a tub with snap on lid made of a material such as polypropylene, linear low density polypropylene, or other suitable material. The containers need not be hermetically sealed or pressurized to provide the dough with good microbial stability under refrigeration temperatures. A shrink band may be included to provide evidence of tampering.

The dough is workable under normal refrigeration conditions, generally about 35-55° F. (1-13° C.). By “workable”, it is meant that the consumer can readily remove the dough from the container or can, and can flatten the dough into the customary form and shape of a pizza crust. In some embodiments, the pizza dough may be sold in a form that is suitable for use as a pizza crust. The dough is simply removed from the package, optionally rolled, and then baked under normal conditions, e.g., in a 350-375° F. (176-191° C.) oven for a sufficient amount of time to fully cook the product. The dough will retain its leavening properties and microbial stability for at least about 90 days under refrigerated conditions. If desired, the dough may be frozen for even longer term storage stability.

The dough is shelf stable for at least about 90 days under refrigerated conditions. By shelf stable it is meant that the dough maintains a desired texture, appearance and taste and produces a baked product having a desired taste, texture and mouth feel. For example, the shelf stable dough described herein does not experience or experiences very little oil migration. As described herein, a combination of the disclosed amounts of oil, shortening and egg may reduce and/or eliminate oil migration (also referred to as oiling out).

The dough bakes into a baked product that has a taste, texture, and mouth feel similar to that of a gluten containing baked product. As described herein, gluten is responsible for the texture and taste of gluten containing (e.g., wheat flour based) baked goods such as cookies, brownies, and breads. Upon hydration, gluten forms a network of fine strands that give the dough the capacity to stretch and/or rise during baking. The elasticity of gluten enables the dough to trap gases, which create open cellular structures upon baking. The gluten-free flour mixture and other ingredients of the dough described herein mimic the functionality of the gluten containing mixture such that the resulting baked product has a color, rise, spread, texture, flavor and/or mouth feel similar and/or comparable to a gluten containing baked product.

Gluten also affects the viscosity of a dough. As described above, gluten forms the structure of the dough. The extent of the network of gluten strands impacts whether a mixture is thin and runny, like a batter, or is thick, like a dough. The dough of the current invention has a rheology similar to that of typical gluten containing doughs. That is, the dough described herein has a satisfactory viscosity and is sufficiently moist to enable the dough to be rolled or formed into a suitable shape for baking. Further, the dough described herein is acceptable for commercial production, enabling the dough to be formed in large scale batches, and pumped and extruded into containers for commercial sale.

### EXAMPLES

The present invention is more particularly described in the following examples that are intended as illustrations only, since numerous modifications and variations within the scope of the present invention will be apparent to those of skill in the art. Unless otherwise noted, all parts, percentages, and ratios reported in the following examples are on a weight basis.

### Formation of Gluten-Free, Ready-to-Bake Pizza Dough

A variety of gluten-free pizza doughs were formed and tested. Each dough was prepared by combining the ingredients by stirring in a standard mixer such as a Sigma mixer under refrigerated conditions, about 35 to 68° F. (1-20° C.). Each pizza dough was made in a two stage process. In the first stage, all of the dry ingredients were blended together. In the second stage, the fats, water and any flavorings were added to the dry ingredients and are mixed together for an optimum time.

### Texture Analysis (Margarine Spread Test)

A dough sample was placed into a texture analyzer having a female cone-bottomed cylinder. Suitable texture analyzers are available from Stable Micro Systems, United Kingdom, and may be equipped with a TTC spreadability rig also available from Stable Micro Systems. A precisely-matching male cone was lowered into the sample, forcing the sample to flow upwards and outwards. The force required to move the male cone at a constant rate was measured. The measured force is an indication of the ease with which the sample flows, and the spreadability or hardness of the sample.

A suitable pizza dough may have a spread force from about 2500 grams force to about 27,500 grams force. In some embodiments, a suitable pizza dough has a spread force from about 5500 grams force to about 14,000 grams force. In a particular embodiment, a suitable pizza dough has a spread force of about 11,000 grams force.

### Control Formulation

Table 3 provides the composition of the control formulation.

TABLE 3
Control Formulation

| | Weight % |
|---|---|
| | (of total composition) |
| Tapioca Starch | 21.05 |
| Sorghum Flour | 10.55 |
| White Rice Flour | 8.61 |
| Millet Flour | 10.55 |
| Baking Powder | 0.5 |
| Xanthan Gum | 0.75 |
| Guar Gum | 0.25 |
| Dried Egg Whites | 4 |
| Fructose | 4.05 |
| Salt | 2 |
| Brown Sugar | 3.1 |
| Water | 27.15 |
| Bread Flavor #6 Natural | 1.6 |
| Bread Flavor #8 Natural | 0.35 |
| & Artificial | |
| Olive Oil | 1.75 |
| Soybean Oil | 0 |
| Pie shortening | 3.75 |

### Examples A and B

Table 4 provides the compositions for Examples A and B, in which the amount of tapioca starch was varied. In Example A, the amount of tapioca starch was increased to 23.312 percent by weight of the composition while in Example B the amount of tapioca starch was decreased to 18.788 percent by weight of the composition.

TABLE 4
Examples A and B

| | Example A | Example B |
|---|---|---|
| | Weight % | Weight % |
| | (of total | (of total |
| Ingredient | composition) | composition) |
| Tapioca Starch | 23.312 | 18.788 |
| Sorghum Flour | 10.248 | 10.852 |
| White Rice Flour | 8.363 | 8.857 |
| Millet Flour | 10.248 | 10.852 |
| Baking Powder | 0.486 | 0.514 |
| Xanthan Gum | 0.729 | 0.771 |
| Guar Gum | 0.243 | 0.257 |
| Dried Egg Whites | 3.885 | 4.115 |
| Fructose | 3.934 | 4.166 |
| Salt | 1.943 | 2.057 |
| Brown Sugar | 3.011 | 3.189 |
| Water | 26.372 | 27.928 |
| Bread Flavor #6 Natural | 1.554 | 1.646 |
| Bread Flavor #8 Natural | 0.340 | 0.360 |
| & Artificial | | |
| Olive Oil | 1.700 | 1.800 |
| Soybean Oil | 0.000 | 0.000 |
| Pie shortening | 3.643 | 3.857 |
| Glucose Oxidase | 0.005 | 0.005 |

### Examples C and D

Table 5 provides the compositions for Examples C and D, in which the amount of water was varied. In Example C, the amount of water was increased to 27.648 percent by weight of the composition while in Example D the amount of water was decreased to 26.652 percent by weight of the composition.

TABLE 5
Examples C and D

| | Example C | Example D |
|---|---|---|
| | Weight % | Weight % |
| | (of total | (of total |
| Ingredient | composition) | composition) |
| Tapioca Starch | 20.906 | 21.194 |
| Sorghum Flour | 10.478 | 10.622 |
| White Rice Flour | 8.551 | 8.669 |
| Millet Flour | 10.478 | 10.622 |
| Baking Powder | 0.497 | 0.503 |
| Xanthan Gum | 0.745 | 0.755 |
| Guar Gum | 0.248 | 0.252 |
| Dried Egg Whites | 3.973 | 4.027 |
| Fructose | 4.022 | 4.078 |
| Salt | 1.986 | 2.014 |
| Brown Sugar | 3.079 | 3.121 |
| Water | 27.648 | 26.652 |
| Bread Flavor #6 Natural | 1.589 | 1.611 |
| Bread Flavor #8 Natural | 0.348 | 0.352 |
| & Artificial | | |
| Olive Oil | 1.738 | 1.762 |
| Soybean Oil | 0.000 | 0.000 |
| Pie shortening | 3.724 | 3.776 |
| Glucose Oxidase | 0.005 | 0.005 |

### Examples E, F and G

Table 6 provides the compositions for Examples E, F and G, in which the amount of oil was varied. Example E includes 11% oil by weight of the composition, Example F includes 5% oil by weight of the composition and Example G includes 8% oil by weight of the composition.

TABLE 6
Examples E, F and G

| | Example E | Example F | Example G |
|---|---|---|---|
| | Weight % | Weight % | Weight % |
| | (of total | (of total | (of total |
| Ingredient | composition) | composition) | composition) |
| Tapioca Starch | 20.5 | 22.00 | 21.25 |
| Sorghum Flour | 10 | 11.50 | 10.75 |
| White Rice Flour | 8 | 9.55 | 8.80 |
| Millet Flour | 10 | 11.50 | 10.75 |
| Baking Powder | 0.75 | 0.50 | 0.50 |
| Xanthan Gum | 0.75 | 0.75 | 0.75 |
| Guar Gum | 0.25 | 0.25 | 0.25 |
| Dried Egg Whites | 1.75 | 1.80 | 1.80 |
| Fructose | 4.05 | 4.05 | 4.05 |
| Salt | 2 | 2.00 | 2.00 |
| Brown Sugar | 2 | 2.00 | 2.00 |
| Water | 27 | 27.15 | 27.15 |
| Bread Flavor #6 Natural | 1.6 | 1.60 | 1.60 |
| Bread Flavor #8 Natural | 0.35 | 0.35 | 0.35 |
| & Artificial | | | |
| Olive Oil | 5 | 2.00 | 3.50 |
| Soybean Oil | 6 | 3.00 | 4.50 |
| Pie shortening | 0 | 0 | 0 |
| Glucose Oxidase | 0 | 0.005 | 0.005 |

### Examples H, I and J

Table 7 provides the compositions for Examples H, I and J in which the amount of egg and/or gum was varied, with the oil set at 11% by weight of the composition.

TABLE 7
Examples H, I and J

| | Example H | Example I | Example J |
|---|---|---|---|
| | Weight % | Weight % | Weight % |
| | (of total | (of total | (of total |
| Ingredient | composition) | composition) | composition) |
| Tapioca Starch | 20.05 | 20.28 | 20.63 |
| Sorghum Flour | 9.55 | 9.78 | 10.13 |
| White Rice Flour | 7.60 | 7.83 | 8.18 |
| Millet Flour | 9.55 | 9.78 | 10.13 |
| Baking Powder | 0.50 | 0.50 | 0.50 |
| Xanthan Gum | 0.75 | 0.75 | 0.38 |
| Guar Gum | 0.25 | 0.25 | 0.13 |
| Dried Egg Whites | 3.60 | 2.70 | 1.80 |
| Fructose | 4.05 | 4.05 | 4.05 |
| Salt | 2.00 | 2.00 | 2.00 |
| Brown Sugar | 2.00 | 2.00 | 2.00 |
| Water | 27.15 | 27.15 | 27.15 |
| Bread Flavor #6 Natural | 1.60 | 1.60 | 1.60 |
| Bread Flavor #8 Natural | 0.35 | 0.35 | 0.35 |
| & Artificial | | | |
| Olive Oil | 5.00 | 5.00 | 5.00 |
| Soybean Oil | 6.00 | 6.00 | 6.00 |
| Pie shortening | 0 | 0 | 0 |
| Glucose Oxidase | 0.005 | 0.005 | 0.005 |

### Examples K and L

Table 8 provides the compositions for Examples K and L, which include increased egg and sugar, and in which the amount of oil was varied. Example K includes 6.5% oil by weight of the composition and Example L includes 8% oil by weight of the composition.

TABLE 8
Examples K and L

| | Example K | Example L |
|---|---|---|
| | Weight % | Weight % |
| | (of total | (of total |
| Ingredient | composition) | composition) |
| Tapioca Starch | 21.1250 | 20.7500 |
| Sorghum Flour | 10.6250 | 10.2500 |
| White Rice Flour | 8.6750 | 8.3000 |
| Millet Flour | 10.6250 | 10.2500 |
| Baking Powder | 0.5000 | 0.5000 |
| Xanthan Gum | 0.7500 | 0.7500 |
| Guar Gum | 0.2500 | 0.2500 |
| Dried Egg Whites | 2.7000 | 2.7000 |
| Fructose | 4.0500 | 4.0500 |
| Salt | 1.9950 | 1.9950 |
| Brown Sugar | 3.1000 | 3.1000 |
| Water | 27.1500 | 27.1500 |
| Bread Flavor #6 Natural | 1.6000 | 1.6000 |
| Bread Flavor #8 Natural | 0.3500 | 0.3500 |
| & Artificial | | |
| Olive Oil | 2.7500 | 3.5000 |
| Soybean Oil | 3.7500 | 4.5000 |
| Pie shortening | 0 | 0 |
| Glucose Oxidase | 0.0050 | 0.0050 |

The doughs were tested using the texture analysis (margarine spread test) described above. The test results (in grams force) are summarized below in Table 9.

TABLE 9
Texture Analysis Results

| | Margarine Spread Test |
|---|---|
| | (Average Force Data) |
| Example | (grams force) |
| Control | 10,733 |
| A | 16,700 |
| B | 6,270 |
| C | 11,978 |
| D | 9,902 |
| E | 6,358 |
| F | 26,210 |
| G | 12,997 |
| H | 3,067 |
| I | 3,521 |
| J | 4,094 |
| K | 7,711 |
| L | 6,647 |

In comparing Example A and Example B, it can be seen that increasing the tapioca starch content, relative to the Control Formulation, results in a stiffer dough while decreasing the tapioca starch content, relative to the Control Formulation, results in a less stiff dough.

In comparing Example C and Example D, it can be seen that increasing the water content, relative to the Control Formulation, results in a stiffer dough while decreasing the water content, relative to the Control Formulation, results in a less stiff dough

In comparing Examples E, F and G, it can be seen that varying the oil content affects the stiffness of the dough. Example E, with 11% oil by weight of the composition, has a stiffness less than that of the Control Formulation (1.75% by weight oil) while Example F, with 5% oil by weight has a stiffness higher than that of the Control Formulation or Example E. Example G, with 8% oil by weight of the composition, has a stiffness intermediate that of the Control Formulation and Example F.

In comparing Examples H, I and J, which each include 11% oil by weight of the composition, it can be seen that varying the egg or gum content does not have a substantial impact on dough stiffness, although each of Examples H, I and K have a stiffness that is significantly less than that of the Control Formulation.

In comparing Examples K and L, which each include high (relative to the Control Formulation) amounts of egg and sugar, it can be seen that varying the oil content has a minor effect on stiffness, as the stiffness results for Examples K and L do not vary substantially from each other. It can be seen in comparing Example L (8% oil, increased sugar) with Example G (8% oil) that the increased sugar content (3.1% by weight versus 2% by weight) does have an impact on stiffness, as Example G has a stiffness value that is about double that of Example L.

Various modifications and additions can be made to the exemplary embodiments discussed without departing from the scope of the present invention. For example, while the embodiments described above refer to particular features, the scope of this invention also includes embodiments having different combinations of features and embodiments that do not include all of the above described features.

1. A composition comprising:
a gluten-free flour mixture in an amount from 45% to 55% by weight of the composition, the gluten-free flour mixture comprising rice flour in an amount of less than 12% by weight of the composition and at least one of tapioca starch, sorghum flour, millet flour and combinations thereof;
dried egg whites in an amount from 1.75% to 4.5% by weight of the composition;
at least one oil in an amount from 1.5% to 2% by weight of the composition;
shortening in an amount from 3% to 7% by weight of the composition;
water in an amount from 26% to 33% by weight of the composition;
ethanol in an amount from 1% to 2% by weight of the composition; and
sucrose in an amount of less than 5% by weight of the composition,
wherein the composition has a water activity of 0.93 or lower.

2. The composition of claim 1, further comprising at least one gum in an amount from 0.5% to 2% by weight of the composition.

3. The composition of claim 2, wherein the gum includes at least one member selected from the group consisting of: xanthan gum and guar gum.

4. The composition of claim 1, further comprising fructose in an amount from 3.5% to 4.5% by weight of the composition.

5. The composition of claim 1, wherein the sucrose is in an amount from 2% to 3.5% by weight of the composition.

6. The composition of claim 1, wherein the rice flour is in an amount from 7% to 10% by weight of the composition.

7. The composition of claim 1, wherein the composition comprises from 36% to 48% by weight of the composition of tapioca starch, sorghum flour, millet flour and combinations thereof.

8. The composition of claim 7, wherein the tapioca starch is in an amount from 15% to 25% by weight of the composition.

9. The composition of claim 7, wherein the sorghum flour is present in an amount from 8% to 20% by weight of the composition.

10. The composition of claim 7, wherein the millet flour is present in an amount from 8% to 20% by weight of the composition.

11. The composition of claim 1, wherein the composition is free of gluten.

12. A method of manufacturing a raw dough product, the method comprising:
combining:
a gluten-free flour mixture in an amount from 45% to 55% by weight of the raw dough product, the gluten-free flour mixture comprising rice flour in an amount of less than 12% by weight of the raw dough product and at least one of tapioca starch, sorghum flour, millet flour and combinations thereof;
dried egg whites in an amount from 1.75% to 4.5% by weight of the raw dough product;
at least one oil in an amount from 1.5% to 2% by weight of the raw dough product;
shortening in an amount from 3% to 7% by weight of the raw dough product;
water in an amount from 26% to 33% by weight of the raw dough product;
ethanol in an amount from 1% to 2% by weight of the raw dough product; and
sucrose in an amount of less than 5% by weight of the raw dough product,
forming a raw dough product from the combined ingredients; and
packaging the raw dough product, wherein the raw dough product has a water activity of 0.93 or less.

13. The method of claim 12, wherein packaging comprises extruding the raw dough product into a packaging container.

14. The method of claim 12, wherein the raw dough product is gluten-free.
